(19) United States
(12) Patent Application Publication
(10) Pub. No.: US 2010/0138688 A1
(43) Pub. Date: Jun. 3, 2010

(54) MANAGING SERVICE LEVELS ON A SHARED NETWORK

(76) Inventors: Edward A. Sykes, Cary, NC (US); Shobana Narayanaswamy, Kensington, MD (US); Alain J. Cohen, Washington, DC (US); Pradeep K. Singh, Arlington, VA (US); Vinod Jeyachandran, Rockville, MD (US); Vivek Narayanan, Rohnert Park, CA (US); Yevgeny Gurevich, Washington, DC (US); Michael Brauwerman, Seattle, WA (US)

Correspondence Address: ROBERT M. MCDERMOTT, ESQ., 1824 FEDERAL FARM ROAD, MONTROSS, VA, 22520, US

(21) Appl. No.: 12/652,499

(22) Filed: Jan. 5, 2010

Related U.S. Application Data
(62) Division of application No. 11/507,113, filed on Aug. 19, 2006.

(51) Int. Cl. G06F 11/07; G06F 11/00; G06F 15/173

(52) U.S. Cl. 714/4; 709/224; 714/E11.024

(57) ABSTRACT

Devices and methods for modeling and analysis of services provided over a common network include a processor configured to track services connected to the common network through nodes and links; run service models associated with the services under selected conditions, the selected conditions including failure and repair of one of the nodes or links; and propose corrective action and/or change of network resources of the common network to minimize impact of the failure. The processor may also run Network models. The models may be executed successively or simultaneously, and outputs of one model may be used as input to other models, including any necessary conversions for compatibility.

This application is a Divisional of Patent Application 11/507,113, filed Aug. 19, 2006, and claims the benefit of U.S. Provisional Patent Application No. 60/709,723, filed Aug. 20, 2005 and U.S. Provisional Patent Application No. 60/821,018, filed Aug. 1, 2006.

### BACKGROUND AND SUMMARY OF THE INVENTION

The present systems and methods relate to the field of network modeling, simulation, monitoring and dynamically managing service levels on a shared network, including network engineering, network planning, and network management and dynamic allocation of network resources, for predictive problem prevention and problem solving.

Communications networks are increasingly supporting “convergence” in which different application services, e.g., voice, video, business critical data, best effort data, etc., with disparate service infrastructures, are supported on a common network infrastructure. A catch-phrase today in the networking marketplace offering “triple play” services, which simply means offering voice, video and data on a common infrastructure. “Application services” in this context is meant to include distributed services with service-specific component elements (service-specific network devices, servers, etc.) at various locations across a shared communication network that collectively deliver functionality to a distinct set of end users.

Each component element of a service provides some functionality that contributes to the overall functionality of the system supporting the service as a whole. The term “application services” is used herein to also encompass in terminology both Enterprise network environments where the term “applications” prevails, and the Service Provider environment where the term “services” prevails. Henceforth, the term “services” will be used to include either or both of the Enterprise network environments or the Service Provider environment, since the present systems and methods apply equally to both.

Table 1, given below for expository and illustrative purposes illustrates different services that may be supported on a common communications infrastructure (e.g., an IP router network as assumed in the table). Each service can have its own system architecture, its own physical and “logical” topology of supporting devices, its own end users, its own signaling traffic, its own bearer traffic, its own traffic behaviors, traffic patterns and growth patterns, its own quality of service (QoS) requirements, and its own service-specific behaviors, including dependencies on other services.

The confluence of multiple services, such as those in the table 1, on common infrastructure, creates a markedly complex and dynamic system with myriad interdependencies through shared resources, shared protocols, shared physical bandwidth, etc.

Network modeling and simulation systems (here these terms describe such systems deployed standalone or integral to online network management systems) traditionally have had a “one size fits all” approach to network modeling. Rather than representing any sort of service explicitly, there is one implicit service and all the traffic in the model is associated with it. For example, a traditional voice network analysis system describes traffic in terms of Erlangs and provides voice network analysis using mathematics driven off of Erlang traffic inputs—it has no concept of data traffic or services. A traditional data network analysis system (focused on IP), describes network traffic demands in terms of packet arrival rate and packet length distributions and drives its analysis, be it discrete event simulation-based or analytical queueing-based, off of these traffic descriptions—again without service models. Moreover, without a concept of services, these models, with purely a network focus, have lacked representation of the end systems on which services depend and the overall concept of the service itself, and the rules and models necessary to determine whether it is operational.

These traditional approaches to network modeling and management are not sufficient in a converged environment, where fundamentally different application services with disparate requirements for success ride a common network infrastructure. In such an environment, one option for making management decisions is full discrete event simulation of the entire combined system including network, end systems, and the services they support. But this is simply infeasible computationally for realistically sized networks. Accordingly, there is a need for a more feasible approach to network modeling, especially in the context of “next generation” online management systems that rely on model-based reasoning for their functions.

It is an object of the present system to overcome disadvantages and/or make improvements in the prior art.

The present system uses a set of loosely coupled models, where each model is a very efficient model for its domain, a service and/or a network. In particular, the present system includes devices and methods for managing service levels using the same representations of services and networks for both off-line modeling and simulation systems, and on-line systems that include real-time monitoring and management systems that dynamically manage service levels on a shared network by dynamically allocating network resources, for predictive problem prevention and reactive problem solving.

The present devices and methods include a processor which is configured to track services connected to the common network through nodes and links, and changes in service requirements and demand over time; run service models associated with the services under selected conditions, the selected conditions including failure and repair of one of the nodes or links; and propose corrective action and/or a change of network resources of the common network to minimize impact of the failure. The processor may also run network model(s). The models may be executed successively or simultaneously, and outputs of one model may be used as input to other models, including any necessary conversions for compatibility.

The processor may also be configured to dynamically adjust the network resources to minimize impact of the failure. To aid an operation in deciding to reallocate network resources, which may be proposed by the system, a visualization may be provided on a display, where the visualization includes a user interface showing a report with status/indication of the services and the network resources, and effects of changing the network resources.

The services may be represented in terms of at least one of service requirement and level of service. The interconnection of the each service to each other and to the common network may also be represented. The service, interconnections and/or network representations may be changed, and an impact of the change is determined on the services and the common network. Further, a common model may be formed including embedding a set of rules and evaluation functions into the common model; and coupling together selected services and selected elements of the common network that have impact on each other.

As an illustration, consider a three-tiered Web application with the tiers being: the web server, the application server, and the database server. The present invention represents theses entities, as well as the users/subscribers to the application as explicit objects. Further, it associates with the service a rule (or set of rules in general) which, when executed, results in the determination of the condition (e.g., up, down, degraded, etc.) of the service. In the illustration below, the condition is binary (the service is up or down for a given subscriber), but in general it could be one of an arbitrary enumerated set (e.g., up, minor problems, degraded, down, etc.), or a more general quantitative indication (integer, real number, etc.)

A simple up/down rule for the example multi-tiered web application is the following:

For the web service to be “up” for subscriber X, all of the following must be true:
Condition 1: Two-way reachability is required between subscriber X′s desktop computer and the web server.
Condition 2: Two-way reachability is required between the web server and the application server.
Condition 3: Two-way reachability is required between the application server and the database server.
Condition 4: The subscriber's workstation must be “up”.
Condition 5: The web server must be “up”.
Condition 6: The application server must be “up”
Condition 7: The database server must be “up”.

All of the conditions constituting the rule above must be true for the service to be up. Evaluating each condition may require an evaluation function. Conditions 1 through 3 require “Reachability”, which is evaluated using a complex evaluation function that determines whether a pair of IP addresses can communicate over the network infrastructure (e.g., subscriber desktop IP address to web server IP address) and, if so, along what path. In the present invention, this evaluation is done by running a routing model (flow analysis) of the IP network infrastructure based on data collected from the network.

Reachability also could be determined by directly collecting forwarding tables from the network and “walking” them to see if there is a path, an alternative also supported today.

System status information is similar, although its evaluation function is trivial. Status could be set offline by the user, for instance, in a what-if analysis of failing a device, or it could be information received from the operational environment—e.g., a device failure event notification. In either case—online or off line, the same rule is evaluated to determine the status of the service (in general, for each subscriber).

Note that the system can and does provide an iterative failure analysis in which each device (and indeed each common network device such as a router) can be failed in turn, and the survivability of the service is evaluated.

The above illustration can be considerably expanded through further description of the invention. First, in a more realistic representation of a web-based application, there are typically n web servers for load balancing and redundancy. So Condition (5) could be “at least k of n web servers must be up”. Or a range could be defined such that when less than k, but more than m, web servers are up the service is considered to be “degraded”, taking the service's condition set beyond binary.

The evaluation functions can be far more complex and useful than simply reachability. For instance, propagation delay can be accumulated along the path the routing analysis computes for each communicating pair (e.g., subscriber desktop to web server), and the total compared to an SLA. The service can then be described as up or down (or degraded) based on thresholds of performance for that SLA.

A final and very important point is that the success of one service such as the above, can depend on the success of another service. For example, in the case of the web service example, the subscriber's local DNS (Domain Name Service) could be required to be “up” in order to resolve the address of the web server. The DNS service could have its own Rules and Evaluation Functions described analogously to the above.

In order for this service dependency to be evaluated, the present invention supports cascaded computation of rules and evaluation functions, e.g., the application service rule above, with the addition of the DNS requirement, will automatically trigger the rules and evaluation functions associated with DNS.

Further, the present invention maintains a log of the order in which the rules and evaluation functions were executed and records comprehensive results for each step and evaluation outcome for each rule. By maintaining this log and record, the system supports not only computation of the top-level status of the service (e.g., the application web service is “down” for subscriber X, but allows the user of the system to fully report on the traversal of the rules and evaluation functions to understand the nature of the failure (e.g., SLA violation between the subscriber and the web server, or the subscribers DNS service is down because of a reachability issue with the DNS server, etc.)

As pointed out earlier, all of the above discussion applies equally to the domain of offline modeling and simulation and the domain of network management. In the former, the analysis can be hypothetical; in the latter, the analysis, including all of the evaluation functions (such as a routing model), are applicable to real world analytics supporting network management that is driven by operational network and service data, and traditional management information (e g , running the above evaluation in response to a notification that a common network router has failed to determine which subscribers to which services are down/degraded/unaffected).

In this environment, where the services rules and evaluation functions are run in response to real world events, the system can be configured to issue service-related alarms (service x is failed). Additionally, the logs and results permit the user of the system to understand the precise reason for the failure, i.e., its root cause.

Further, since the system embeds a set of rules and evaluation functions collectively with the ability to model the operational environment, that same set of models can be used to reason about “fixes” to problems identified. For example, if the root cause of a web application failure for a given subscriber is an SLA violation due to congestion in some part of the network, the user of the system can explore alternative means of routing the subscribers' traffic by changing IP link weight metrics.

This same process can be automated. In one embodiment of the invention, in which the IP network is MPLS-based, the system can be configured to optimize MPLS explicit path-based routing to minimize congestion throughout the network. This automated design action is called in response to a network event, such as a failure notification. The impact of the failure is automatically analyzed as previously described, and if that analysis shows the result to be sufficiently bad, the MPLS rerouting design action is run automatically to locate a set of network changes that repair or ameliorate the problem.

The present system provides a systematic treatment of multiple distributed services with individual and interrelated behaviors in a predictive modeling and simulation context. For example, the present system enables scalable modeling and analysis for proactive problem prevention and reactive problem solving in a network supporting multiple service networks, with an emphasis on, but not exclusive focus on, managing service levels.

### BRIEF DESCRIPTION OF THE DRAWINGS

The invention is explained in further detail, and by way of example, with reference to the accompanying drawings wherein:

FIG. 1 shows an illustrative network problem report in accordance with an embodiment of the present system;

FIG. 2 shows a service problem report in accordance with an embodiment of the present system;

FIG. 3 shows an abstraction for VoIP service success between two city pairs as an example of a rules-based abstract in accordance with an embodiment of the present system;

FIG. 4 shows a simulation procedure in accordance with an embodiment of the present system;

FIG. 5 shows two folders in accordance with an embodiment of the present system;

FIG. 6 shows a user interface including a menu in accordance with an embodiment of the present system;

FIG. 7 shows a dialog to enter/edit the service evaluation function in accordance with an embodiment of the present system;

FIGS. 8, 9 and 10 show examples of the service-related survivability analysis reports in accordance with an embodiment of the present system; and

FIG. 11 shows a device in accordance with an embodiment of the present system.

### DETAILED DESCRIPTION

The following are descriptions of illustrative embodiments that when taken in conjunction with the following drawings will demonstrate the above noted features and advantages, as well as further ones. In the following description, for purposes of explanation rather than limitation, specific details are set forth for illustration. However, it will be apparent to those of ordinary skill in the art that other embodiments that depart from these details would still be understood to be within the scope of the appended claims. Moreover, for the purpose of clarity, detailed descriptions of well-known devices, circuits, and methods are omitted so as not to obscure the description of the present system.

It should be expressly understood that the drawings are included for illustrative purposes and do not represent the scope of the present system. In the accompanying drawings, like reference numbers in different drawings designate similar elements.

For purposes of simplifying a description of the present system, as utilized herein regarding the present system, the following terms include meanings as follows: the term “network” intended to include to mean the common network infrastructure interconnecting the devices associated with any service and providing resources that may be shared among the services including dedicated resources that may be dynamically adjusted to prevent or minimize failures and impacts thereof

Further, the term “service network” is intended to include the union of the network and all the remaining entities necessary to support the entire service, such as end user devices, gateway devices at technology transition points, signaling devices, backup devices, etc. The term “problem” is intended to include an issue either intrinsic to the common network infrastructure (e.g., router link congestion), intrinsic to a specific service (e.g., how much capacity do I need to grow my VPN service by 30% in the New York market?), or intrinsic to both (e.g., finding an error in a router access control list configuration change that “broke” signaling among voice over Internet Protocol (VoIP) devices). The present systems and method automatically abstract configuration changes of individual devices used by the common network and/or services from policies related to the common network and services.

Table 1 below shows service illustrations, such as multiple services over a common IP infrastructure:

TABLE 1

| | | | QoS | Service-specific |
|---|---|---|---|---|
| Service Name | Devices | Traffic | Requirements | Behaviors |
| Voice over IP | Media gateways, | Signaling - H.323 | Inter-device | Signaling failovers |
| (VoIP) | Soft-switches | among VoIP | signaling delay | and load balancing |
| | (Both types attach directly | devices | <100 ms | among soft switches |
| | to IP router network) | Bearer - point-to- | Inter-device | |
| | | point telephone | Bearer path delay | |
| | | calls (full duplex) | <50 ms | |
| | | Traffic call volume | Bearer path | |
| | | described in Erlangs | packet jitter | |
| | | To be transported as IP | <30 ms | |
| | | packets using G.729a | Bearer path | |
| | | encoding with 2 voice | packet loss | |
| | | frames/packet; often | <1% | |
| | | modeled as a on/off | Each voice call | |
| | | Markov - Modulated | must have MOS | |
| | | Rate Process (MMRP) | greater than 4 | |
| Broadcast | VoD servers, | Signaling - IGMP | Inter-device | Failover behavior, |
| Video on Demand | Content storage systems, | & proprietary | Bearer path delay | Encoder rate |
| (VoD) | | mechanisms | <500 ms | adaptation |
| | | Bearer - | Bearer path | |
| | | unidirectional | packet jitter | |
| | | IP multicast | <30 ms | |
| | | traffic using MPEG4 | Bearer path | |
| | | encoding; highly bursty | packet loss | |
| | | traffic source - can be | <0.1% | |
| | | modeled as an | | |
| | | interrupted MMRP | | |
| | | with many states | | |
| Multi-tiered Web | Web server farm, | Etc. | Etc. | Etc. |
| Application | Storage network, | | | |
| | Application servers, | | | |
| | Database servers | | | |
| Etc. | Etc. | Etc. | Etc. | Etc. |

One component of the present system includes the treatment of each service as a separate conceptual “thread” throughout the entire process of using predictive modeling and simulation to prevent and solve data network and service network problems. The elements and operations that contribute to this end include:
simultaneously intertwined simulation and modeling for the shared network and multiple service networks;
providing critical decision analysis of the impact on the shared network of changes in a service and cross-service impact analysis of changes in one service on another service;
globally managing or optimizing the network (e.g., engineering bandwidth, performing traffic engineering, configuring QoS, etc.) to support both common infrastructure metrics within engineering tolerances and service-specific metrics within their service level thresholds; and
visualization and reporting of all of the common infrastructure and service-specific inputs, simulation results, and optimization results from the above analyses and optimizations.

Considerations and operations related to the simultaneously intertwined simulation and modeling for the shared network and multiple service networks include:

1. For the shared network common among services, this produces key metrics relevant to performance engineering, planning and problem solving related to that network. Service level requirements and metrics may be expressed in terms of network performance metrics. It should be noted that one component of the present system includes using simulation and modeling in the shared network context to generate problem-solving information at the granularity of services (i.e., within the context of overall engineering rules for the shared network). For each important or desired statistic on a device, link, tunnel, queue, interface, etc. in the shared network generated by modeling and simulation, the system reports on that statistic based on conformance to engineering targets for the shared network.

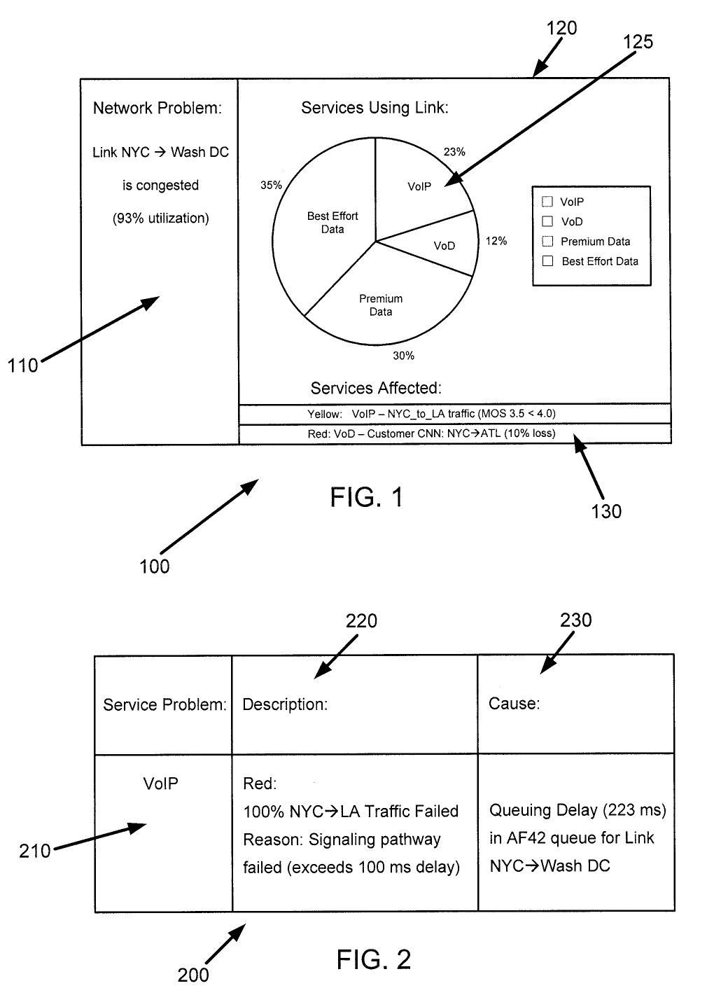

Further, the system computes: (1) new measures on the contribution of each service to that statistic (where appropriate), (2) causal effects that are service-related, (3) service impacts (both the direct impact of the statistic on affected services as well as indirect effects where that statistic is input to a service-specific performance or impact analysis function), and (4) service-specific analysis measures. These are all illustrated in an exemplary network problem report 100 shown in FIG. 1. Causal relationships may be represented among the respective service models to enable simulation of change effects on the services.

As shown in FIG. 1, the network problem report 100 indicates information related to hardware or network infrastructure as well as services using the network infrastructure. For example, a hardware or link problem is indicated in a first area 110, namely, congestion of the link between New York City and Washington, DC. In a second area 120, the various services using this link is provided, where a pie graph 125 is displayed showing percentages of various services that are being provided on or consuming the NYS to DC link or all the links associated with the network, namely, 23% for VoIP, 12% for VoD, 30% for Premium Data, and 35% for Best Effort Data.

In a further or third area 130, information is provided related to the services that have been or may be affected by the current problem (i.e., the congestion in the NYC to DC link shown in the first area 110). Of course, the data may be presented in various ways, such as bar graphs instead of the pie chart 125, and may include further indications, such as being color coded. For example, as shown in the third area 130, the VoIP service may be color coded, such as colored yellow to indicate a potential problem, a relatively minor problem, or reduced quality, such as an MOS of 3.5 which is less then the needed value 4 as shown in the QoS column for VoIP of Table 1; while the VoD data may be a different color, such as color coded red to indicate the existence of a (more severe or catastrophic) problem, namely, the 10% loss of data or services in VoD between NYC and Atlanta (in this example, the end-to-end VoD traffic flow from NYC to Atlanta is routed over the congested network link between NYC and Wash DC).

FIG. 2 shows an illustrative example of a service problem report 200 related to VoIP as indicated in a first column 210, with a detailed description of the VoIP problem provided in the second column 220. In particular, the second column 220 indicates that 100% of the NYC to LA traffic failed, where further indication, icons or attention grabbers, such as color coding in red may also be provided related to the severity of the problem. As shown in the second column 220, the reason for the failure is also provided, namely, signaling pathway failure, where the delay exceeds 100 ms, which is above the “QoS Requirements” column in Table 1, first entry, (related to VoIP service as noted in the first column of Table 1), namely, that the QoS requirement of an inter-device signaling delay is less then 100 ms. A third column 230 includes the causes of the problem noted in the first and second columns 210, 220.

2. Simulation and modeling for each service network, end system to end system, which produces key metrics relevant to performance engineering, planning, and problem solving related to that service network. Here another component of the present system includes allowing simulation and modeling of the service in a separate model from the model of the shared network, and using simple causal abstractions to couple the models loosely. It should be noted that there are many embodiments of this approach. One example is the following embodiment with a loosely coupled service model and a network model:

In one instance of a hybrid Time Domain Multiplex (TDM) based voice and VoIP network, for example, routing of the TDM-based voice calls occurs with the legacy voice network “seeing” the VoIP network as one (big) TDM switch. In this case, a traditional TDM voice analysis model (e.g., reduced load approximation) may be used to model TDM level voice behavior, such as blocking, overflows, etc. This TDM level model determines the ingress/egress points for voice traffic over the VoIP network. Once the TDM model has been run, the voice calls that ride the VoIP network are converted to IP flows as part of the simulation. The IP router network model is run with the offered load and produces packet statistics like delay, jitter, and loss, specific to the voice flows/voice services. Finally, the packet-level statistics may be converted back to voice service specific measures on quality, such as a standards-based model called Mean Opinion Score (MOS) using what is known as the ITU E-Model of the International Telecommunication Union (ITU) analysis standard.

The hybrid TDM-based and IP-based voice network example is one where the rules and evaluation functions that compute status of the overall VoIP service can be recursive, as follows. For simplicity, assume that all voice traffic originates and terminates in the TDM domain and the IP voice network is used as an embedded core network for long distance transport of voice traffic. To analyze this hybrid environment, first, the TDM voice network analysis (e.g., a reduced load approximation model) is run for the offered voice traffic (say Erlangs between each city pair in the network). This analysis performs TDM domain routing of the traffic. That routing determines the ingress and egress points on the IP network of voice flows that will traverse it (the IP network appears to be just another “big” voice switch in the TDM analysis—when in fact its trunk interfaces are actually media gateways distributed over a large geographical area). Next, the voice traffic (Erlangs) must be converted to IP flow traffic (using the appropriate CODEC and packetization parameters—e.g., G.711 with 2 voice frames per packet). Next, the VoIP analysis must be run using a separate model—an IP flow analysis with traffic sources and sinks being the media gateways on the edge of the IP router network. After this analysis, it can and often is the case that certain of the IP voice flows cannot be supported, so these are deemed “blocked”. In the real network, these calls would be blocked one at a time as they are setup and the blocking notification would occur in signaling. In the service evaluation environment, they are blocked as a group since they are offered as a group. This information is fed back to the TDM domain model (e.g., 15% of NYC to LA traffic is blocked—i.e., cannot be setup).

This last step leads to the recursion. The traffic that can be setup has changed. So the TDM domain model must be rerun, with the reduced traffic load, and again it will embed the VoIP flow analysis. The recursion repeats until all offered traffic to the VoIP domain is supported, at which point all the routes and performance metrics are known for both the TDM and IP voice domains. The outcome (result) is that a percentages of each source-destination pair's traffic flow for voice is supported (i.e., not blocked). This can translate into the service status directly (voice support from NYC to LA is at 85%) or more likely it is thresholded with a success/failure rule: “Voice service from NYC to LA is up if less than 1% of its voice traffic is blocked”.

As an additional illustration of the elegance of the solution, consider that the VoIP bearer service (what has been discussed so far) could be dependent on VoIP signaling working, i.e., a VoIP signaling service. So, for example, a set of rules and evaluation functions can describe the fact that for any pair of media gateways on the VoIP network to pass bearer traffic, they must be able to signal, which requires that each of their local softswitches be up, that each media gateway has reachability to its local softswitch, and that the two softswitches have reachability to each other. (Of course, more complicated rules, like SLAs, are appropriate here, since signaling latency is an important issue in this particular environment.) Thus in the recursion described previously, the VoIP flow analysis evaluation cascades with a VoIP signaling analysis. Again with logs and detailed recording of all the outcomes of the steps in the process, the system can elegantly produce a report such as:

“Voice traffic from NYC to LA is 15% blocked because VoIP signaling from the NYC media gateway to the SF media gateway is down. This is due to a IP-unreachability caused signaling failure between the NYC and SF softswitches because router Cisco_Chicago is down”.

Another component of the service network simulation modeling aspect of the present system includes comparing the requirements of a service (e.g., QoS regarding a latency from one component to another) for successful operation against the actual QoS it receives on the converged network. This element uses a flexible set of abstractions that may capture causal relationships between service behaviors and network behaviors.

As noted, the present system includes providing critical decision analysis of the impact on the shared network of changes in a service and providing cross-service impact analysis of changes in one service on another service, such as:

A. Impact of common infrastructure and service specific configuration changes;

B. Analysis of network and service configuration errors (often caused by inconsistencies between the service and the network);

C. Impact of network failures on services and impact of service failures on other services and the network;

D. Analyzing cascading changes in interrelated QoS configurations and policies on service levels in the above;

E. Analyzing service specific failover and load balancing behaviors (typically ignorant of the underlying communications infrastructure); and

F. Supporting deployment of new services and growth in existing services in all of the analyses named above.

It should be noted that the present system not only includes configuration analysis, network modeling and simulation, a failure analysis, but also includes analysis that focuses on services in the described context, that includes globally managing or optimizing the network to support both common infrastructure metrics within engineering tolerances and service-specific metrics within corresponding service level thresholds, as well as visualization and reporting of all of the common infrastructure and service-specific inputs, simulation results, and optimization results from the above analyses and optimizations to effectively manage the available common network infrastructure and individual services in view of the needed and on-going services.

As noted, the present system uses a set of loosely coupled models of both the services and network domains, where each model is particularly suited and very efficient for its particular domain. The term “loosely coupled” is used to mean that a system of rules and evaluation functions permit the embedding of different modeling techniques within one another and provide for coordination in the overall analysis, including moving data inputs and outputs among the individual models. For example, a service may require that two of its components are reachable across a common IP network. This is a simple rule which embeds an evaluation function (reachability). The evaluation function, however, requires running a complex IP network routing model in order to return with its simple (binary—yes or no) answer.

In addition, to multiple loosely coupled models in the converged multi-services environment, a service is treated as a first class object throughout the entire software infrastructure necessary for network modeling and simulation, including in data collection, analyses, visualization and reporting, optimization, etc. Such a treatment of a service allows the modeling and simulation systems to support more efficient and effective predictive activities, such as planning and preventative problem solving (e.g., predicting behavior under failures in the process of protecting against those failures), to support troubleshooting network or application service level problems, and to support service level management and optimization.

For such efficient operations, the network model (the union of each service's own devices and traffic, and the common network infrastructure interconnecting all service-specific devices) maintains a complete “set of books”, so to speak, for each service individually, as well as for their common network infrastructure. Each “set of books” may be in a different mathematical language, one in the language for the common infrastructure and one each in the language of the different services. For example, in the voice world, “pin drop” quality may translate into scoring the subjective quality of a telephone call using a standard model called Mean Opinion Score (MOS). In the IP data networking world, the various concerns may include link congestion, packet delay, jitter and loss.

The present system systematically treats application services throughout the predictive network modeling and simulation environment, from initial inputs to application service specific outputs.

For example, first, the system accepts as input a description of the common communications infrastructure shared among services, such as the following and the like:
1. Network devices and their configuration, for example, IP routers and their detailed protocol/level configuration;
2. Interconnections among network devices including bandwidth where it is available; and
3. Overhead traffic information, including traffic the network devices generate themselves to keep the network up and running

In addition to the above three inputs, the present modeling and simulation system also accepts as an additional input the description of each service it supports. Dimensions of this additional input and capabilities or descriptions of each service include:
1. Service architecture and elements including the logical tiers of devices distributed around a communications network necessary to support the service;
2.Service configuration, for example, for a VoIP service, media gateway x signals to a local softswitch y normally, or to a backup local softswitch z if y is congested, and uses remote softswitch q if both y and z are unreachable;
3. Service topology including location and logical interconnections of the service elements;
4. Service attachment points to the common multi-services communications infrastructure;
5.End user traffic volumes and traffic patterns including the amount of end user traffic using the service and its distribution (point-to-point, point-to-multipoint, etc.) across the network, which may vary over time due to business hour, seasonal, or systematic growth;
6.Traffic models for the end user traffic produced by the service including stochastic models of end user session start-up patterns, session lengths, the traffic they produce, etc., often with service-specific forms and units;
7. Traffic growth patterns over time including rate of growth, ways in which growth is manifested, e.g., more users versus greater traffic volume per user, etc.;
8.Service level requirements and metrics including thresholds of service level that may be converted and expressed in terms of direct network performance metrics (e.g., packet delay, jitter loss)
9. Data collection systems, e.g., CDRs for voice traffic, Netflow for data traffic, etc., varying both in form of information collected (individual sessions versus aggregates, units, identification of from/to relationships, formats, etc.);
10.Service-specific performance analysis which may be uniquely associated with the application service of its performance acceptability;
11.Routing policy including engineering rules as to how the service should be placed on paths through the common communications infrastructure; and
12. QoS policy including engineering rules as to how the service should be supported in network devices (e.g., queueing configuration in a router—what queue it should be assigned to, etc.).

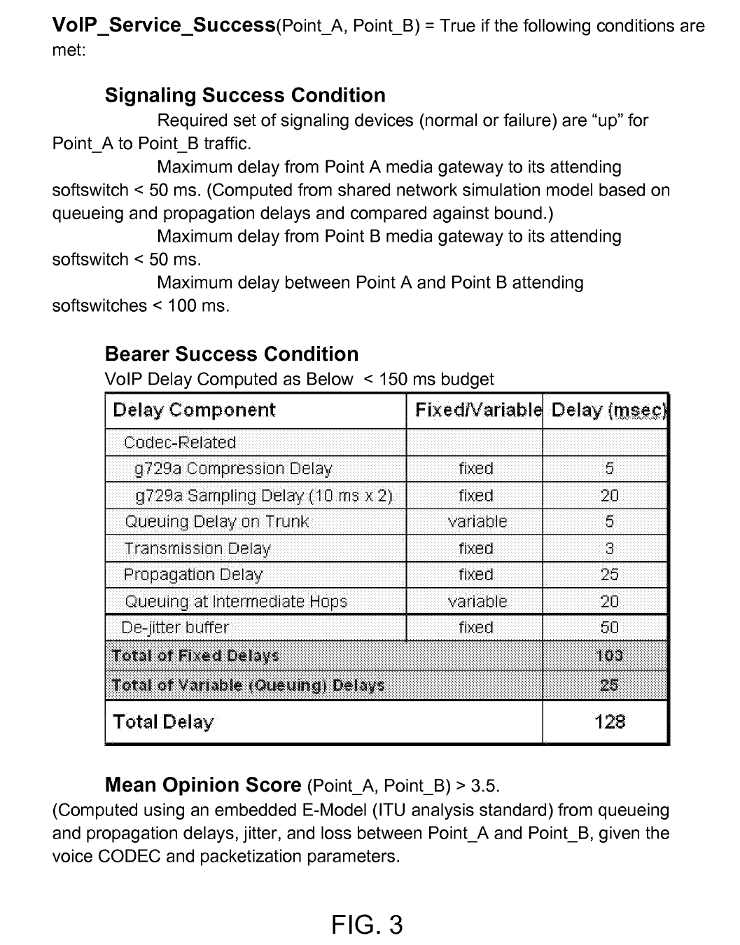

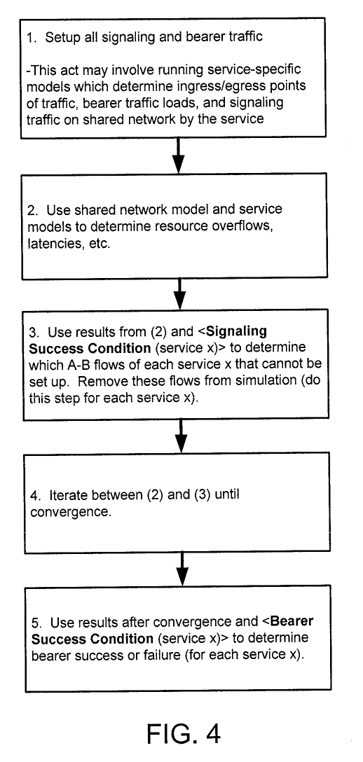

For each service as appropriate, the system performs the following operations as necessary, whether automatically or in response to user action, changes in service levels, conditions, requirements traffic etc. including changes in network configuration and resources to the various services:
1. Models the service to the extent necessary to describe the volume and entry and exit points of a service specific bearer (i.e., end user) and describes signaling traffic necessary to solve the problem set of interest using all or part of the available information. For example, for capacity planning, signaling traffic may be ignored, while for troubleshooting certain VoIP failures, signaling-related traffic may be all that is needed in most situations.
2. Supports import of service-specific traffic descriptions over time, including with multiple time granularities (e.g., some characterization of peak hour traffic for each of the last 12 months, daily traffic for the last month, and hourly traffic for the last week), all in the “native form” of the service;
3. Supports the user in trending and forecasting service traffic in native form, and in means appropriate to the service;
4. Performs algorithmic/mathematical conversions from the description of the service in its native parameters to the description of the service in the parameters of the common communications infrastructure, e.g., converting voice traffic among PSTN side ports of media gateways (media gateway-to-media gateway in Erlangs) to packet traffic on the IP side of the media gateways (packet interrarrival and packet length parameters between IP addresses);
5. Supports in automated form the configuration of network devices to conform to network-wide user policies by service on routing. For example, voice traffic is mapped into an MPLS LSP (Multiprotocol Label Switching Label Switched Path) specific to voice at each provider edge device and that LSP is routed using resources assigned to DiffServ-Aware Traffic Engineering Class Type 0;
6. Supports in automated form the configuration of network devices to conform to network-wide user policies on QoS. For example, voice traffic on MPLS is marked with EXP bit setting 100, and will traverse a low latency queue configured on each core router;
7. Analyzes the network as a whole using network modeling or simulation. This includes complex interactions between services and common communications infrastructure (e.g., congestion at a network resource due to multiple services sharing it, incongruities between service configuration and common communications infrastructure configuration, cross-impacts among services on QoS (e.g., voice traffic in the priority queue on a router is causing platinum data traffic in another queue to be starved). The types of analyses performed for the common network infrastructure and services, which may be performed simultaneously or in series to determine a network or service failure, including cascaded service failures, include:
Performance analysis
Failure analysis (also known as the closely related Survivability Analysis)
Security analysis
Policy analysis
Root cause analysis
Configuration audit and pre-deployment change validation.
8. Maintains simple causal abstractions, including rule-based abstracts, of success/failure of a service that can be tested using modeling/simulation results computed from service network and/or shared network models. These abstractions may be maintained as a record to assist a user with analysis of service failures. FIG. 3 is an example of a rules-based abstract of this type.
9. Permits those abstracts to be used to causally link separate service and network models. FIG. 4 gives a simulation procedure of this type with Service Abstractions Embedded.
10. Uses the above abstractions to provide “root cause” analysis for common network problem solving activities and focused service-related troubleshooting (both in a planning context, and in using modeling and simulation for troubleshooting a real network based on collected data from it);
11. Provides deployment analysis for a new service with dimensions including all of the analyses in the previous bullet;
12. Provides optimization for new deployments;
13. Provides analysis results for the common infrastructure in a service-oriented fashion, e.g., which services use which links and devices and by how much, what services occupy each queue on each interface in the network, etc.
14. Provides analysis results for each service in the mathematical description appropriate for the service, either by extracting and translating the analysis results of the collective analysis into results by service, or performing additional algorithmic analysis that is service specific (such as an algorithm for estimating signaling latencies among voice devices and comparing them against signaling-related timers in the voice gear which could cause the devices to declare signaling entities down); and
15. Supports visualization of the service elements, traffic among them, and where appropriate, separately the traffic they imply for the common communications infrastructure.

The present systems and methods provide a mechanism to represent a high-level Service concept to enable users to perform service-oriented analyses, including determination of the impact of network configuration problems/failures on the ability of the network to provide each specific service. As described, the services are represented as configured services in the network model which may receive results of service model analysis runs which may be converted for compatibility with the network model, as necessary.

The present systems and methods including software applications provide a mechanism to create services, display, and configure them. The analysis of the service is performed in concert with (“as part of” in the sense that the user executes one command) a flow analysis run (now extended to perform service-specific analysis in addition to its original common network infrastructure analysis function), and reports are generated and displayed as part of the particular model, e.g. a particular service or part(s) thereof including all or parts of relevant network elements, components, devices and interconnections.

In one embodiment of the invention, to aid with defining and analyzing services, two types of top-level objects are used: Service Elements and Service User Group objects:
1. Service Elements
   A service definition includes all key components that impact its availability. For example, a web service may include the web servers that host the service as well as any other services (such as DNS service) that it depends on. There is no restriction imposed by the software on what kinds of objects can be included in a service. Illustratively, nodes, links, demands and indeed services can be components of a service, where the term “nodes” here is general as well—it can and often would include application-specific servers (e.g., for a multi-tiered web application, web servers, application servers, database servers, etc.), service specific devices (e.g., for VoIP, media gateways, softswitches, etc,)
   Service Element Alias: All elements of a service have an associated alias, which is auto-defined by a core engine running the software application in accordance with the present systems and methods. This alias is displayed next to the element name in the network browser treeview. The convention for these alias names includes:
   Xn: where ‘X’ depends on the element type (‘N’ for nodes, ‘S’ for services, ‘D’ for demands); and ‘n’ is a monotonously increasing number for that element type. (N1, N2, etc.)
2. Service User Group Elements
   A service user group includes the end users of a service (the service clients) and the services that are used by these end users or clients. Including a particular client node in a service user group implies that this client uses all the services that are also members of that group.

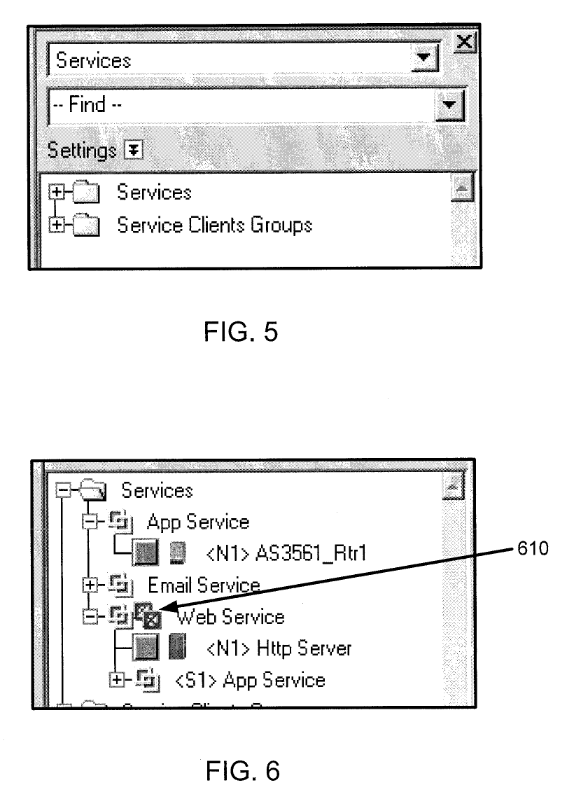

Services and Service User Groups may be visualized in the network browser. An option related to “Services” is added to an ‘arrange-by’ menu in the network browser. This will contain two folders, one for Services and the other for Service User Groups, as shown in FIG. 5. Alternative and additional visualizations can include service-specific graphical canvas views of services alone or overlaid on a view of the common network infrastructure (in its entirety or filtered to show relevant portions).

A service analysis includes at least two parts, namely, server status and reachability. Server Status relates to whether a server is up or down (as determined by its ‘condition’ attribute), while reachability indicates whether or not the servers can reach the service's dependent services. For example, if a demand is included as one of the service elements, the routability of the demand is included in the service analysis. The service is considered down if the demand is unroutable. Other characteristics of the demand (such as SLAs) may be used to influence the status of the service. More complex service-specific analyses can be employed here as well: for example, computing the VoIP MOS score of an end-to-end voice service demand, based on packet delay, jitter, and loss that a demand experiences as it traverses the network infrastructure.

The success or failure of a service user group may also be defined in terms of its inability to access one or more services. This would be relevant for security-related analyses, to determine which clients have access to certain services.

The service analysis also includes using service evaluation function(s). A service object is associated with an ‘Evaluation Function’, which can be specified by the user. This function is evaluated by the Core engine to determine if a service is up or down. Illustratively, the evaluation functions include Boolean statements having Boolean combinations of expressions such as:
Expression=Expression Boolean_Operator Expression
where ‘Expression’ may be either an element alias (‘N1’, ‘S1’, etc.) or a supported canned function such as an ‘Is_Connected’ canned function. The ‘Boolean_Operator’ may be ‘AND’ or ‘OR’. Parentheses may be used to group expressions and specify the evaluation order.

Element aliases may also be evaluated. For example, an element alias, such as ‘N1’, may be evaluated by determining if that element is up or down. For nodes, this may be based on a check of the ‘condition’ attribute. For demands, this may be based on whether the demand is routable or not. For services, this may be based on an analysis of the service's evaluation function.

The ‘Is Connected’ function may have the following syntax:
Is_Connected (Element Alias, Element Alias, Reachability Condition, Source Port, Destination Port, Protocol)
Where:
   Reachability Condition: may be either ‘ALL’ or ‘ANY’, where the Default value may be ‘ANY’;
   Source/Destination Port: which ports to use when testing the reachability;
   Protocol: Which protocol to use when testing for reachability.

In one embodiment, only the first two parameters (the element aliases) may be required; reasonable default values may be used for the others.

A default evaluation function may also be used where, if there is no evaluation function specified, a default analysis behavior may be used. For example, a service may be considered to be up if all its components are up, and all the servers can reach all the dependent services.

Other application programming interfaces (APIs) may also be used, such as one referred to as Ets API. An Ets_Service API is provided to allow Ets clients to query the network for configured services, perform the services analysis and retrieve status and failure messages from the services analysis.

Various reports and user interfaces (UIs) may be provided. For example, FIG. 6 shows top level menu items that may include the following options:
Topology>Services>Create Service: This will create a new service object and will display it in the network browser.
Topology>Services>Create Service User Group: This will create a new service user group object and will display it in the network browser.
Topology>Services>Analyze Services: This will perform an analysis of the services and internally update the status of the service elements.
Topology>Services>Visualize Status: Based on the cached results of the service analysis operation (either from the above menu item, from data directly collected in the operational environment, or from a network simulator run, such as a FLAN run), the service treeview elements visualization may be updated. If a service is down, an additional ‘failure’ icon may be displayed next to the service icon as shown by icon 610 in FIG. 6. If a service is up, no additional icon may be displayed. Similarly, if a service client (a node member of a service clients group) is impacted, an additional ‘failure’ icon may be displayed next to its regular icon.

Other UI items include Topology>Services>Clear Visualization, which will remove any additional ‘failure/impacted’ icons from the treeview elements in the network browser. Import and export options may also be provided where a Topology>Services>Import allows users to import a service definition from previously exported services definition (.sdi) file. This will bring up a file-chooser dialog, to allow users to select and import the file.

The services elements (nodes, demands, etc.) may be referred to by their hierarchical name so that an exported file may be reliably imported into another network that contains objects of the same name and hierarchy. If an object is missing, it will be skipped and the service definition will not include it. This may be useful both in the modeling and simulation environments and network/system management contexts equally, as services may not always be discovered from the operational environment, so a degree of manual configuration may be required that is then desirable to persist as the discoverable parts of the network and services are repopulated over time as change occurs.

Topology>Services>Export allows users to export their service definition to a text file (extension .sdi), for import into a new version of the network, for example.

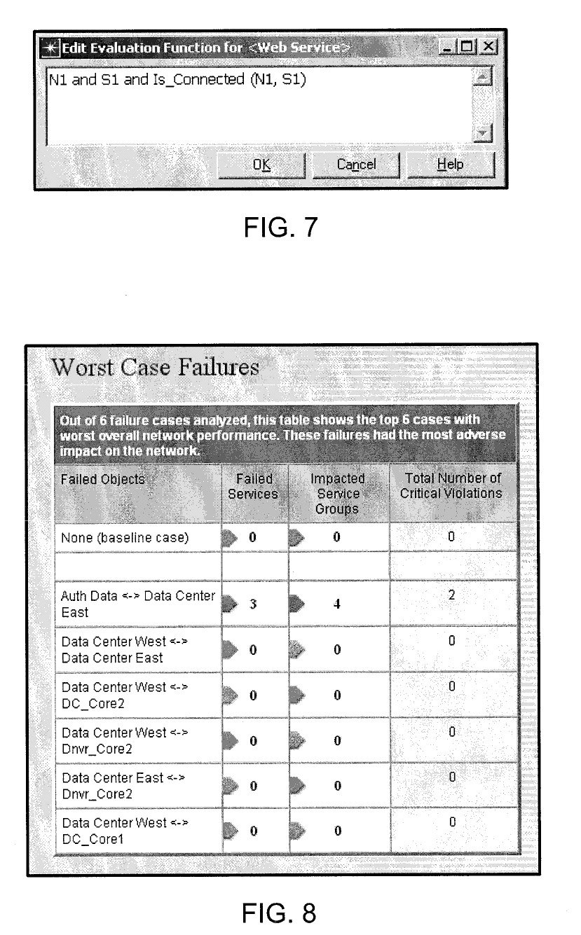

A Service Right-Click Menu may also be provided where right-clicking on a service object in the network browser will display the following items in the menu:
Set Name: Allows user to easily change the name of the service;
Edit Evaluation Function: Displays a dialog to enter/edit the service evaluation function, as shown in FIG. 7;
Edit Attributes (Advanced): Displays the Edit Attributes dialog in advanced mode'
Add Selected Objects to Service: User may first select the objects, and then click on this menu item to add the selected objects to the service;
Remove Selected Objects from Service: User may first select the objects, and then click on this menu item to remove the selected objects from the service; and
Delete: Deletes the service.

A Service User Group Right-Click Menu may also be provided where right-clicking on a service user group object in the network browser may display the following items in the menu:
Set Name: Allows user to easily change the name of the service;
Edit Attributes (Advanced): Displays the Edit Attributes dialog in advanced mode;
Add Selected Objects to Service User Group: User may first select the objects, and then click on this menu item to add the selected objects to the service user group;
Remove Selected Objects from Service User Group: User may first select the objects, and then click on this menu item to remove the selected objects from the service user group; and
Delete: Delete the service user group.

Service analysis may be initiated by a Flow Analysis run. A new checkbox ‘Evaluate Services’ may be added to a ‘Configure Flow Analysis’ dialog. The list of generated flow analysis (recall, this is what executes the set of models for common infrastructure and services) reports may be enhanced to include services-specific reports. These reports may provide information on the defined services and service user groups, and their status. Drilldown tables may be provided to list the reason(s) for the failures of any service and/or the impacted status of service users. Additional reports may provide such things as consumption of network resources by each service, i.e., reports that more broadly characterize the impact each service has on the network.

A Survivability Analysis feature may also be enhanced to support reporting on services. Thus, users may determine the survivability of services when particular network components fail. Some examples of the service-related survivability analysis reports are shown in FIGS. 8-10, results of which may be maintained in a service status log file.

FIG. 8 shows an illustrative analysis report including worst case failure analysis for failed objects and the impact of the failed objects including failed services, impacted service groups and total number of critical violations in accordance with an embodiment of the present system.

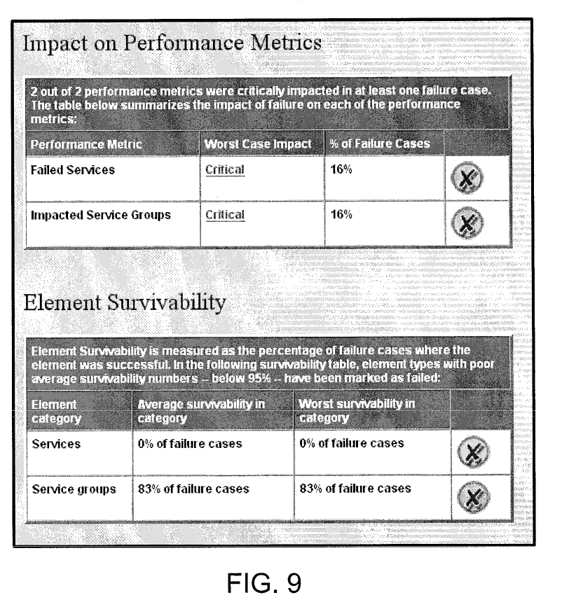

FIG. 9 shows an illustrative analysis report including impact on performance metrics and element survivability in accordance with an embodiment of the present system.

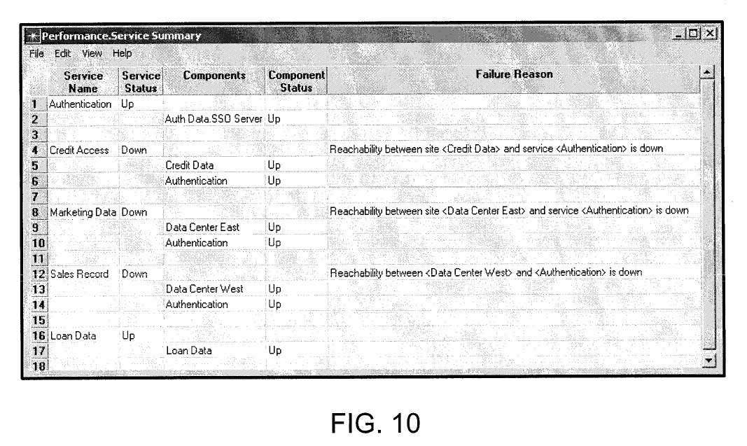

FIG. 10 shows an illustrative analysis report including a performance service summary including service names, service status, components involved, component status, and failure reasons for failed services including interconnection data when applicable.

Other features of the present systems and methods include automatic creation of services. For example, a method for automatically creating application level services may be based on packet trace information. The trace of any given application contains information about different tiers involved. In a modular service structure, each of these tiers may be a separate service. Each of these services may be dependent on other services as well. For example, assume a trace of a web-based application with 3 tiers, the user, the web server and a database server. The information may easily translate into a web service and a database service with the user being a consumer of the web service and the web service being a consumer of the database service. These set of services may be deployed on the modeled network and each service component, user, web server and database server can be represented by one or many network elements. Note that in cases where IP address information is available for components of a service (e.g. its web server, its softswitch, etc.), that information can be used to automatically connect the service elements to the common network infrastructure.

Further, additional visualizations and reports may be provided. For example, network views may be provided that filter the topology visualization to only display the service-related components of the network. Other visualizations can include displaying the service elements and showing the paths that the traffic between them would traverse (or where traffic is unavailable, similarly, the path that traffic might take, i.e., as a consequence of reachability requirements). Further, such paths could be displayed or otherwise characterized with data collected from the operational network along the path; for example, color-coding the path at each hop based on the link congestion collected from router MIB-II data. Many such visualizations are possible (delay, loss, errors, queue information, etc.).

Additional and Custom Evaluation Functions may also be provided. Illustratively, the custom function (Is_Connected) may be extended to support additional functions which may take into account SLA criteria, for example. Thus, the success/failure status of a service may be tied to specific SLAs. These functions may be based on a plug-in mechanism, thus allowing for customization by the users.

As described, the present systems and methods apply equally to the cases: (i) where the common network and services networks are “modeled” in a standalone virtual environment, and (ii) where part or all of the common network and service networks information is collected from the operational environment and the “model” includes some data that was collected from the real world. In one embodiment, the present systems and methods continually collect data (events, topology and configuration, performance data, traffic, etc.) from just the common network, for example, and the constructs of the services are an add-on in the management system that allows seeing the impact on a service of a change in the common network. Data may also be collected on some or all of the services to auto-populate the services models and know service-related traffic.

The present systems and methods include modeling and simulation (i.e., offline) systems and methods, as well as network management (i.e., online) systems and methods. Further, the present systems and methods combine both offline and online management systems and methods that have services overlays thus providing leading analytics in network management. These analytics involve model-based reasoning combined with online data collection. For example, a simulation model embedded in an online network management system may be used to understand the impact on a service of an event, e.g., received from an online fault management system. All of the information collected may be stored and utilized at a later time to assist in network and services analysis.

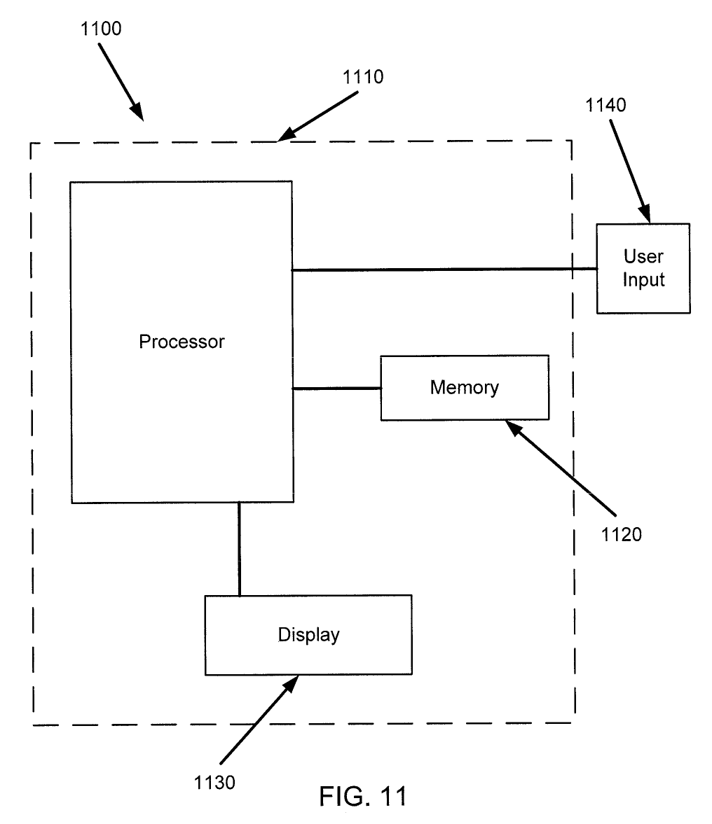

FIG. 11 shows a device 1100 in accordance with an embodiment of the present system. The device has a processor 1110 operationally coupled to a memory 1120, a display 1130 and a user input device 1140. The memory 1120 may be any type of device for storing application data as well as other data, such as network topology data, coordinate data for network objects, label data for objects, interconnectivity of objects, etc. The application data and other data are received by the processor 1110 for configuring the processor 1110 to perform operation acts in accordance with the present systems and methods. The user input 1140 may include a keyboard, mouse, trackball or other devices, including touch sensitive displays, which may be stand alone or be a part of a system, such as part of a personal computer, personal digital assistant, or other display device for communicating with the processor 1110 via any type of link, such as a wired or wireless link. The user input device 1140 is operable for interacting with the processor 1110 selection and execution of desired operational acts. Clearly the processor 1110, memory 1120, display 1130 and/or user input device 1140 may all or partly be a portion of a computer system or other device.

The methods of the present system are particularly suited to be carried out by a computer software program, such program containing modules corresponding to one or more of the individual steps or acts described and/or envisioned by the present system. Such program may of course be embodied in a computer-readable medium, such as an integrated chip, a peripheral device or memory, such as the memory 1120 or other memory coupled to the processor 1110.

The computer-readable medium and/or memory 1120 may be any recordable medium (e.g., RAM, ROM, removable memory, CD-ROM, hard drives, DVD, floppy disks or memory cards) or may be a transmission medium (e.g., a network comprising fiber-optics, the world-wide web, cables, or a wireless channel using time-division multiple access, code-division multiple access, or other radio-frequency channel). Any medium known or developed that can store and/or transmit information suitable for use with a computer system may be used as the computer-readable medium and/or memory 1120.

Additional memories may also be used. The computer-readable medium, the memory 1120, and/or any other memories may be long-term, short-term, or a combination of long-term and short-term memories. These memories configure processor 1110 to implement the methods, operational acts, and functions disclosed herein. The memories may be distributed or local and the processor 1110, where additional processors may be provided, may also be distributed or may be singular. The memories may be implemented as electrical, magnetic or optical memory, or any combination of these or other types of storage devices. Moreover, the term “memory” should be construed broadly enough to encompass any information able to be read from or written to an address in the addressable space accessed by a processor. With this definition, information on a network is still within memory 1120, for instance, because the processor 1110 may retrieve the information from the network for operation in accordance with the present system.

The processor 1110 is capable of providing control signals and/or performing operations in response to input signals from the user input device 1140 and executing instructions stored in the memory 1120. The processor 1110 may be an application-specific or general-use integrated circuit(s). Further, the processor 1110 may be a dedicated processor for performing in accordance with the present system or may be a general-purpose processor wherein only one of many functions operates for performing in accordance with the present system. The processor 1110 may operate utilizing a program portion, multiple program segments, or may be a hardware device utilizing a dedicated or multi-purpose integrated circuit.

Of course, it is to be appreciated that any one of the above embodiments or processes may be combined with one or more other embodiments or processes or be separated in accordance with the present system.

Finally, the above-discussion is intended to be merely illustrative of the present system and should not be construed as limiting the appended claims to any particular embodiment or group of embodiments. Thus, while the present system has been described with reference to exemplary embodiments, it should also be appreciated that numerous modifications and alternative embodiments may be devised by those having ordinary skill in the art without departing from the broader and intended spirit and scope of the present system as set forth in the claims that follow. In addition, the section headings included herein are intended to facilitate a review but are not intended to limit the scope of the present system. Accordingly, the specification and drawings are to be regarded in an illustrative manner and are not intended to limit the scope of the appended claims.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function;
e) any of the disclosed elements may be comprised of hardware portions (e.g., including discrete and integrated electronic circuitry), software portions (e.g., computer programming), and any combination thereof;
f) hardware portions may be comprised of one or both of analog and digital portions;
g) any of the disclosed devices or portions thereof may be combined together or separated into further portions unless specifically stated otherwise;
h) no specific sequence of acts or steps is intended to be required unless specifically indicated; and
i) the term “plurality of” an element includes two or more of the claimed element, and does not imply any particular range of number of elements; that is, a plurality of elements can be as few as two elements, and can include an immeasurable number of elements.

What is claimed is:

1. A method of assessing performance of a communications network, comprising:
defining a plurality of services provided on the network;
for each service:
defining each of a plurality of components required for providing the service, and
defining one or more criteria for providing an acceptable level of service;
determining, using at least one determination function, performance parameters related to the components of the network;
comparing, by a network analysis system, the performance parameters to the one or more criteria of the plurality of services; and
identifying, by the network analysis system, one or more of the plurality of services that fail to achieve the acceptable level of service based on the one or more criteria, and at least one criteria that was not achieved that caused the service to fail to achieve the acceptable level of service.

2. The method of claim 1, wherein the determination function includes a simulation of a model of the network that includes models of the components to provide the performance parameters related to the components of the network.

3. The method of claim 2, including:
introducing a fault in the network,
determining subsequent performance parameters, and
identifying one or more of the plurality of services that fail to achieve the acceptable level of service upon introduction of the fault.

4. The method of claim 2, including:
introducing a change in the network,
determining subsequent performance parameters, and
identifying one or more of the plurality of services that had failed to achieve the acceptable level of service before introduction of the change, and achieved the acceptable level of service upon introduction of the change.

5. The method of claim 1, wherein the determination function includes a connectivity determination between select components of the network.

6. The method of claim 5, wherein the connectivity determination includes an assessment of entries in one or more routing tables of components on the network.

7. The method of claim 5, including:
introducing a fault in the network,
determining subsequent performance parameters, and
identifying one or more of the plurality of services that fail to achieve the acceptable level of service upon introduction of the fault.

8. The method of claim 5, including:
introducing a change in the network,
determining subsequent performance parameters, and
identifying one or more of the plurality of services that had failed to achieve the acceptable level of service before introduction of the change, and achieved the acceptable level of service upon introduction of the change.

9. The method of claim 1, wherein the determination function includes one or more rules that are applied to features of the components to provide a binary result for a given service parameter.

10. The method of claim 9, wherein the plurality of rules include service rules associated with each of the plurality of services and network rules associated with the network.

11. The method of claim 10, wherein the determining performance parameters related to the components of the network includes:
executing the service rules to obtain service outputs;
converting the service outputs to inputs compatible with the network rules; and
executing the network rules using the converted service outputs as inputs.

12. The method of claim 1, including:
introducing a fault in the network,
determining subsequent performance parameters, and
identifying one or more of the plurality of services that fail to achieve the acceptable level of service upon introduction of the fault.

13. The method of claim 1, including:
introducing a change in the network,
determining subsequent performance parameters, and
identifying one or more of the plurality of services that fail to achieve the acceptable level of service upon introduction of the change.

14. The method of claim 1, including:
introducing a change in the network,
determining subsequent performance parameters, and
identifying one or more of the plurality of services that had failed to achieve the acceptable level of service before introduction of the change, and achieved the acceptable level of service upon introduction of the change.

15. The method of claim 1, including:
defining other criteria for providing an acceptable but degraded level of service for one or more of the plurality of services,
comparing the performance parameters to the one or more other criteria, and
identifying one or more of the plurality of services that achieve the acceptable but degraded level of service based on the other criteria.

16. The method of claim 1, wherein:
at least one service includes a plurality of traffic types, each traffic type having one or more criteria for providing the acceptable level of service, and
identifying the one or more plurality of services that fail to achieve the acceptable level of service includes identifying the one or more traffic types corresponding to the criteria that was not achieved.

17. The method of claim 1, including:
identifying a set of available resources on the network,
accumulating a set of required resources based on the criteria for providing an acceptable level of service for each service, and
comparing the set of required resources to the set of available resources to identify scarce resources.

18. The method of claim 17, including allocating the scarce resources among the plurality of services.

19. The method of claim 1, including maintaining a log of status of each service, including, for each change of status, the criteria corresponding to the change of status.

20. The method of claim 1, wherein the plurality of components required for providing a first service includes one or more second services.

21. The method of claim 8, wherein identifying the one or more of the plurality of services that fail to achieve the acceptable level of service includes identifying one or more of the second services that cause the first service to fail to achieve the acceptable level of service.

22. The method of claim 8, including identifying each service that is affected by a failure of an other service to achieve its acceptable level of service.

23. The method of claim 1, wherein the plurality of components of at least one service includes one or more components that are specific to the service, and one or more network components that are in common with at least one other service.

24. A system comprising:
a memory that is configured to store a plurality of services provided on a network, each service being characterized by a plurality of components required for providing the service, and one or more criteria for providing an acceptable level of service,
a display device, and
a processor that is configured to:
determine, using at least one determination function, performance parameters related to the components of the network,
compare the performance parameters to the one or more criteria of the plurality of services; and
identify one or more of the plurality of services that fail to achieve the acceptable level of service based on the one or more criteria, and at least one criteria that was not achieved that caused the service to fail to achieve the acceptable level of service, and
provide one or more reports to a user based on the failure of the one or more services to achieve the acceptable level of service.

25. The system of claim 24, including a simulator that is configured to simulate a model of the network that includes models of the components, to provide the performance parameters related to the components of the network.

26. The system of claim 24, wherein the processor is further configured to:
introduce at least one of a fault and a change in the network,
determine subsequent performance parameters, and
identify one or more of the plurality of services that fail to achieve the acceptable level of service based on the subsequent performance parameters.

27. The system of claim 24, wherein the processor is further configured to introduce a change in the network,
determine subsequent performance parameters, and
identify one or more of the plurality of services that had failed to achieve the acceptable level of service before introduction of the change, and achieved the acceptable level of service upon introduction of the change.

28. The system of claim 24, wherein the determination function includes a connectivity determination between select components of the network.

29. The system of claim 28, wherein the determination function includes a plurality of rules that are applied to features of the components to provide a binary result for a given service parameter.

30. The system of claim 29, wherein the plurality of rules includes service rules and network rules, and the processor is configured to:
execute the service rules to obtain service outputs,
convert the service outputs to inputs compatible with the network rules, and
execute the network rules using the converted service outputs as inputs.
